(19) United States
(12) Patent Application Publication
(10) Pub. No.: US 2018/0264385 A1
(43) Pub. Date: Sep. 20, 2018

(54) LOW DEFORMATION FILTER MEDIA

(71) Applicant: FLSmidth A/S, Valby (DK)

(72) Inventor: Brent Stokes, The Woodlands, TX (US)

(21) Appl. No.: 15/517,905

(22) PCT Filed: Oct. 14, 2015
(86) PCT No.: PCT/US15/55454

§ 371 Date: Apr. 7, 2017

Related U.S. Application Data
(60) Provisional application No. 62/063,562, filed on Oct. 14, 2014.

(51) Int. Cl. B01D 39/16; B32B 37/06; B32B 37/08; B32B 37/10; B32B 5/02; B32B 5/26

(52) U.S. Cl. CPC B01D 39/1623; B32B 37/06; B32B 37/08; B32B 37/10; B32B 2307/718; B32B 5/26; B01D 2239/0668; B32B 2262/0253; B32B 2262/0276; B32B 5/022

(57) ABSTRACT

A filter media for dewatering slurry is disclosed. The filter media comprises: a first layer comprising a polypropylene-containing fabric, the polypropylene-containing fabric comprising felt having a random needled felt weave; a second layer comprising a polypropylene-containing fabric, the polypropylene-containing fabric comprising felt having a random needled felt weave; and a third layer provided between the first layer and the second layer, the third layer comprising a polyester-containing fabric, the polyester-containing fabric comprising monofilament polyester. A method of manufacturing the filter media is further disclosed.

### CROSS-REFERENCE TO RELATED APPLICATIONS

This application is a U.S. National stage § 371 application of PCT/US2015/055454, filed on 14 Oct. 2015 and titled “LOW DEFORMATION FILTER MEDIA”, which claims priority to and the benefit of United States Provisional Patent Application No. 62/063,562 filed on Oct. 14, 2014 and titled “LOW DEFORMATION FILTER MEDIA.” The contents of the aforementioned applications are hereby incorporated by reference in their entirety for any and all purposes as if fully set forth herein.

### FIELD OF THE INVENTION

The current invention relates to filter media, primarily for use in large scale industrial dewatering processes, and methods of manufacturing and using the same.

### BACKGROUND OF THE INVENTION

Most needled felt is formed from polypropylene which is heated, and then melt blown (hot blown while molten) onto a moving bed. The fibers of the melt-blown polypropylene comprise a certain size. Typically, 18 ounce needled felt is approximately 18 ounces per square yard. During melt blowing, the molten polypropylene is extruded into open air and cooled on the moving bed, and needled, to create a felt product which is capable of filtering.

Melt blown polypropylene is difficult to clean when used as a filtering medium. Accordingly, after the polypropylene is melt blown and needled, it typically passes through a “calendaring” machine, wherein hot steel rollers may glaze the exposed sides. The problem with old-fashioned needled felt used in filter media, is that it tends to deform against filter plate profiles and geometries. This can negatively affect filtration performance, create wear spots, open holes, or concentrate non-filtrate material in certain portions of the filter media—in particular, portions of the filter media that lie adjacent to filtrate ports, “pips” (e.g., on a filter plate of a horizontal filter press), or the like.

According to some embodiments, a multi-filament lightweight webbing (i.e., “scrim”) may be placed between two blown sheets. The scrim may be used to increase the tensile strength or burst strength of the needled felt/scrim composition (i.e., “supported needle felt”). The scrim between the two blown sheets may also serve to prevent elongation in wet filtration applications or rupture in dry filtration applications. It is important that scrim does not get damaged by the needling process, otherwise the structural performance characteristics of the scrim could become compromised.

Supported needle felt has long been a select choice for use in filtration, particularly horizontal filter presses, because of its soft and lofty nature. It is very compressible, and therefore tends to seal very well on plate edges of horizontal filter presses (e.g., FLSmidth EIMCO® AFP IV automated filter presses). In short, supported needle felt lends itself to filter presses, because it commissions new machines good, takes up most mechanical “slop”, and is very forgiving.

Drawbacks of conventional supported needle felt include rapid dirtying, and low structural stability. For example, one problem that currently exists with scrim-supported needle felt filter media, is that the filter cloth tends to deform into and/or around pips on the filter plate. This cuts down the effective filtering surface area, and negatively impacts filter performance. However, to date, the aforementioned disvantages of using supported needle felt filter media overcome the structural disadvantages. Therefore, to date, these drawbacks have been deemed within the art as being acceptable compromises.

### OBJECTS OF THE INVENTION

According to some embodiments, an object of the present invention is to make existing scrim-supported needle felt more structurally/mechanically robust;

According to some embodiments, an object of the present invention is to make a filter media comprising needled felt lay flat over a raised pip on a filter plate of a horizontal filter press;

According to some embodiments, another object of the present invention is to maintain at least some of the advantages of conventional scrim-supported needle felt, such as softness, loftiness, compressibility, and ability to seal and/or dampen during filtration operations.

These and other objects of the present invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

A filter media for dewatering slurry is disclosed. In some embodiments, the filter media comprises: a first layer comprising a polypropylene-containing fabric, the polypropylene-containing fabric comprising felt having a random needled felt weave; a second layer comprising a polypropylene-containing fabric, the polypropylene-containing fabric comprising felt having a random needled felt weave; and a third layer provided between the first layer and the second layer, the third layer comprising a polyester-containing fabric, the polyester-containing fabric comprising monofilament polyester. In some embodiments, the first layer may be single-glazed, via a calendaring step. In some embodiments, the second layer may be single-glazed, via a calendaring step. In some embodiments, the first and second layers may be single-glazed, via a calendaring step. In some embodiments, the third layer may be provided most adjacent non-glazed portions of the first and second layers, such that single-glazed surfaces form outer working surfaces of the filter media, and the third layer may be internal to the filter media. In some embodiments, the filter media may further include a fourth layer comprising an adhesive web. In some embodiments, the fourth layer may be pre-applied to at least one of the first and second layers.

In some embodiments, the adhesive web may comprise a polyolefin having a melting temperature range of approximately 68° C.-130° C., a heat resistance temperature range of approximately 65-110° C., and a wash resistance temperature of approximately 30° C. In some embodiments, the third layer may have a yarn configuration of monofilament-monofilament, a thread count of approximately 18×18 per inch, a plain weave, a heat set finish, a weight of approximately 12.5 ounces/square yard, and an open area of approximately 45%, may be provided. In some embodiments, the second layer may have a weight of approximately 6 ounces/square yard, a permeability of approximately 20.0-30.0 CFM @ ½″ DWP, a Mullen Burst of approximately 150+, and a maximum continuous operating temperature of approximately 180° F. In some embodiments, the first layer may have a weight of approximately 24 ounces/square yard, a permeability of approximately 5.0-8.0 CFM @ ½″ DWP, a Mullen Burst of approximately 450+, and a maximum continuous operating temperature of approximately 180° F.

A method of manufacturing filter media for dewatering slurry, is also disclosed. The filter media may comprise: a first layer comprising a polypropylene-containing fabric, the polypropylene-containing fabric comprising felt having a random needled felt weave; a second layer comprising a polypropylene-containing fabric, the polypropylene-containing fabric comprising felt having a random needled felt weave; and a third layer provided between the first layer and the second layer, the third layer comprising a polyester-containing fabric, the polyester-containing fabric comprising monofilament polyester. The method may comprise the steps of: providing the third layer between the first layer and the second layer; feeding the first layer, second layer, and third layer into a laminator having heating, cooling, and pressure capabilities; applying heat to the first layer, second layer, and third layer; applying pressure to the first layer, second layer, and third layer; and, cooling the first layer, second layer, and third layer.

In some embodiments, the first layer may be single-glazed, via a calendaring step. In some embodiments, the second layer may be single-glazed, via a calendaring step. In some embodiments, the first and second layers may be single-glazed, via a calendaring step. In some embodiments, the third layer may be provided most adjacent non-glazed portions of the first and second layers, such that single-glazed surfaces form outer working surfaces of the filter media, and the third layer may be internal to the filter media. In some embodiments, the filter media may further include a fourth layer comprising an adhesive web. In some embodiments, the fourth layer may be pre-applied to at least one of the first and second layers.

In some embodiments, the adhesive web may comprise a polyolefin having a melting temperature range of approximately 68° C.-130° C., a heat resistance temperature range of approximately 65-110° C., and a wash resistance temperature of approximately 30° C. In some embodiments, the third layer may have a yarn configuration of monofilament-monofilament, a thread count of approximately 18×18 per inch, a plain weave, a heat set finish, a weight of approximately 12.5 ounces/square yard, and an open area of approximately 45%, may be provided. In some embodiments, the second layer may have a weight of approximately 6 ounces/square yard, a permeability of approximately 20.0-30.0 CFM @ ½″ DWP, a Mullen Burst of approximately 150+, and a maximum continuous operating temperature of approximately 180° F. In some embodiments, the first layer may have a weight of approximately 24 ounces/square yard, a permeability of approximately 5.0-8.0 CFM @ ½″ DWP, a Mullen Burst of approximately 450+, and a maximum continuous operating temperature of approximately 180° F.

In some embodiments, the laminator may be a double belt press laminator with integrated contact heating and cooling. In some embodiments, the double belt press laminator with integrated contact heating and cooling may be a flatbed-laminator system. In some embodiments, the step of applying heat to the first layer, second layer, and third layer may comprise maintaining between approximately 100 degrees F. to 400 degrees F. for approximately 10 seconds to 3 minutes. In some embodiments, the step of applying heat to the first layer, second layer, and third layer may comprise maintaining approximately 300 degrees F. for approximately 60 seconds. In some embodiments, the step of applying pressure to the first layer, second layer, and third layer may comprise maintaining between approximately 1 and 10 lbs of pressure. In some embodiments, the step of applying pressure to the first layer, second layer, and third layer may comprise maintaining approximately 5 lbs of pressure. In some embodiments, the step of cooling the first layer, second layer, and third layer may comprise maintaining between approximately 50 and 100 degrees F. for approximately 10 seconds to 3 minutes. In some embodiments, the step of cooling the first layer, second layer, and third layer may comprise maintaining approximately 75 degrees F. for approximately 60 seconds.

### BRIEF DESCRIPTION OF THE DRAWINGS

To complement the description which is being made and for the purpose of aiding to better understand the features of the invention, a set of drawings is attached to the present specification as an integral part thereof, in which the following has been depicted with an illustrative and non-limiting character:

FIGS. 1-4 are photographs showing a cross-section of a filter media according to some embodiments;

FIG. 5 schematically represents a cross-sectional diagram showing the layers which may be used to form filter media according to some embodiments;

FIG. 6 schematically represents a first composite which may be used to form filter media according to some embodiments;

FIG. 7 schematically represents a second composite which may be used to form filter media according to some embodiments;

FIGS. 8-13 suggest various methods of joining independent and composite layers together.

In the following, the invention will be described in more detail with reference to drawings in conjunction with exemplary embodiments.

### DETAILED DESCRIPTION OF THE INVENTION

The following description of the non-limiting embodiments shown in the drawings is merely exemplary in nature and is in no way intended to limit the inventions disclosed herein, their applications, or uses.

According to some embodiments, a filter media 10 composed of polyester woven goods and monofilament may be provided. In preferred embodiments, a heavyweight layer 20 of needled felt 26 (e.g., 24 ounces per square yard) may be provided. The heavyweight layer 20 may comprise one or more layers of scrim material 24 therein, which supports the needled felt 26. This heavyweight layer 20 may be considered to be the material which does most of the filtration functions. The outer (i.e., “cake/slurry-facing”) side 22 of the heavyweight needled felt may be glazed (i.e., “glazed side” 22) to improve handle-ability, reduce pulling, and mitigate clogging/dirtying. Glazing may be accomplished by any calendaring processes known in the art. The un-glazed inner portion 28 of the heavyweight layer 20 may be placed adjacent a monofilament polyester yarn woven media 40.

On the opposite side of the monofilament polyester yarn woven media, a lightweight cap 60 of needled felt 66 (e.g., 6 ounces per square yard) may be provided. The lightweight cap 60 may comprise one or more layers of scrim material 64 therein, which supports the needled felt 66. The side 68 of the lightweight cap 60 facing the monofilament polyester yarn woven media 40 may preferably be left un-glazed. The outer (i.e., “filtrate-facing”) side 62 of the lightweight cap 60 may be glazed (i.e., “glazed side” 62) to improve handle-ability, reduce pulling, and mitigate clogging/dirtying. As a matter of preference, an adhesive web 30, 50 may optionally be applied between the monofilament polyester yarn woven media 40 and at least one of: the heavyweight layer 20 and the lightweight cap 60. In preferred embodiments, the adhesive web 30, 50 is temperature and/or pressure-sensitive adhesive. In preferred embodiments the adhesive webs 30, 50, if used, are pre-attached to said at least one of: the heavyweight layer 20 and the lightweight cap 60 before the heavyweight layer 20, lightweight cap 60, and monofilament polyester yarn woven media 40 are joined together in a laminator 200. However, as suggested by FIG. 13, one or more optional adhesive webs 30, 50 may be simultaneously joined with the heavyweight layer 20, lightweight cap 60, and monofilament polyester yarn woven media 40.

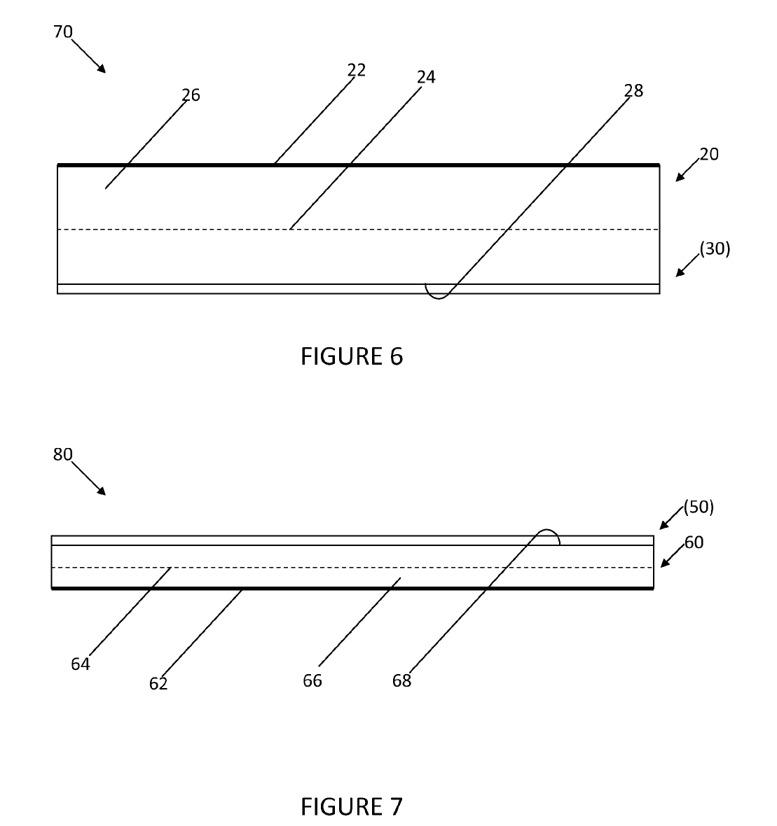

For example, as shown in FIG. 6, a first composition 70 may be made, comprising the heavyweight layer 20, which is pre-attached to an adhesive web 30, wherein the adhesive web 30 is juxtaposed with glazed size 22. Additionally, for example, as shown in FIG. 7, a second composition 80 may be made, comprising the lightweight cap 60, which is pre-attached to an adhesive web 50, wherein the adhesive web 50 is juxtaposed with glazed size 62. If one or more adhesive webs 30, 50 are utilized, it is preferred that they are affixed to the respective layer (i.e., heavyweight layer 20, lightweight cap 60) on the respective layers “un-glazed” side 28, 68.

In some embodiments, the heavyweight layer 20 or first composition 70 may be joined to the lightweight cap 60 or the second composition 80, with the monofilament polyester yarn woven media 40 provided there between. In some embodiments, no adhesive webs 30, 50 may be used, or the monofilament polyester yarn woven media 40 may be treated with an adhesive coat. Various combinations, such as one or more adhesive webs 30, 50 in combination with a polyester yarn woven media 40 may be treated with an adhesive coat, are envisaged, without limitation.

The final composition of a filter media 10 according to embodiments, with the layers together, collectively, are designed to filter similarly as conventional scrim-supported needle felt filter media, that is, with all of the same desirable loft, compressibility, and sealing capabilities. However as an improvement, filter media according to embodiments of the invention may also allow this final composition to be used as a filter media which does not deform around pips and other raised or recessed profiles of a filter plate and which has increased rigidity, reduced stretch, and better structural support. The final composition is further designed to seal well, not deform, and increase hydrodynamic properties of the composition, thereby improving filtration characteristics.

### EXAMPLE 1

POPR-24 Felt Single Glazed, a 100% polypropylene fabric type, having a random needled felt weave, a single glazed finish, a weight of approximately 24 ounces/square yard, a permeability of approximately 5.0-8.0 CFM @ ½″ DWP, a

Mullen Burst of approximately 450+, and a maximum continuous operating temperature of approximately 180° F. may be provided. The POPR-24 Felt filter fabric may be manufactured of 100% polypropylene to yield exceptional chemical resistance at moderate temperatures. The 24.0 ounce/yard construction of the POPR-24 Felt may make it acceptable for use in a wide variety of liquid filtration applications. POPR-24 Felt may provide excellent retention of fine particulate and good cake release characteristics.

POPR-6 Felt Single Glazed, a 100% polypropylene fabric type, having a random needled felt weave, a single glazed finish, a weight of approximately 6 ounces/square yard, a permeability of approximately 20.0-30.0 CFM @ ½″ DWP, a Mullen Burst of approximately 150+, and a maximum continuous operating temperature of approximately 180 ° F. may also be provided.

Moreover, DA-558 Monofilament Polyester, a polyester fabric, having a yarn configuration of monofilament-monofilament, a thread count of approximately 18×18 per inch, a plain weave, a heat set finish, a weight of approximately 12.5 ounces/square yard, and an open area of approximately 45%, may be provided. In some embodiments, the DA-558 may be treated with an adhesive skin coat, however, it is preferred that a pre-attach adhesive be applied to the unglazed side of the POPR-24 and/or the unglazed side of the POPR-6.

Lastly, an efficient, effective, and versatile adhesive, for example, Spunfab POF4002 or similar adhesive web, which has a base chemistry of a Polyolefin, a melting temperature range of approximately 68° C.-130° C., a heat resistance temperature range of approximately 65-110° C., and a wash resistance temperature of approximately 30° C., may be provided. The adhesive web may comprise a weight of approximately 0.5 ounces/square yard, and may come in 57 inch width rolls.

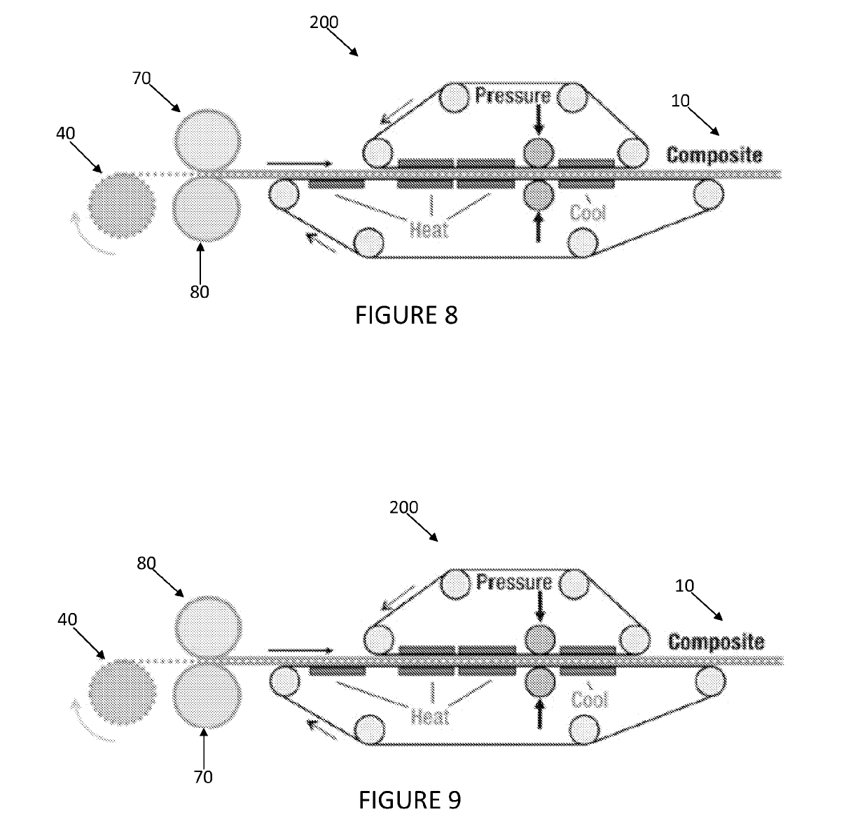

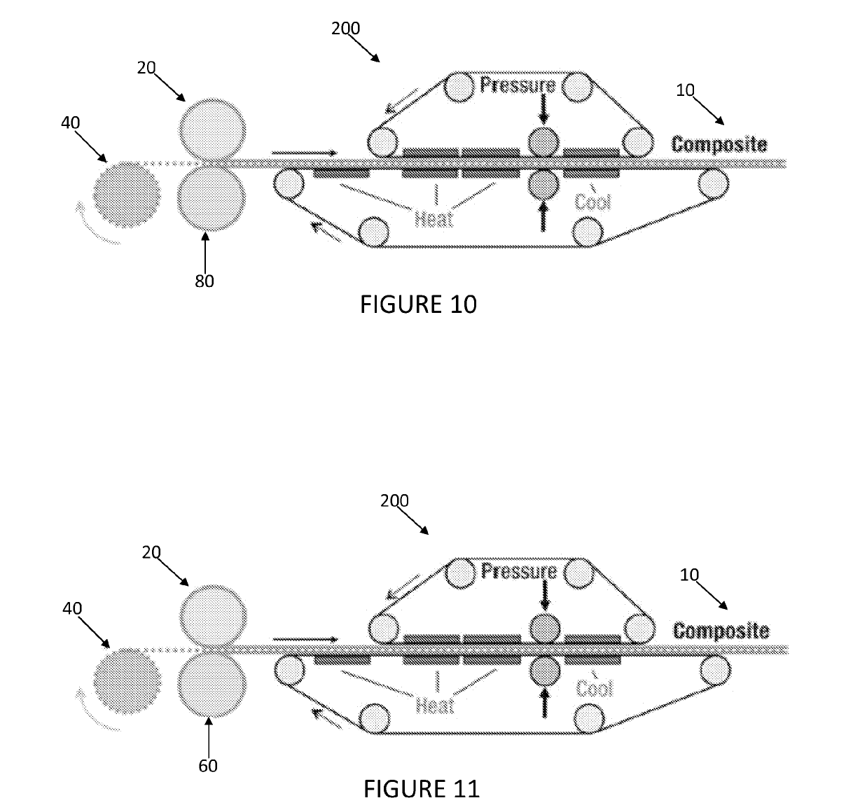

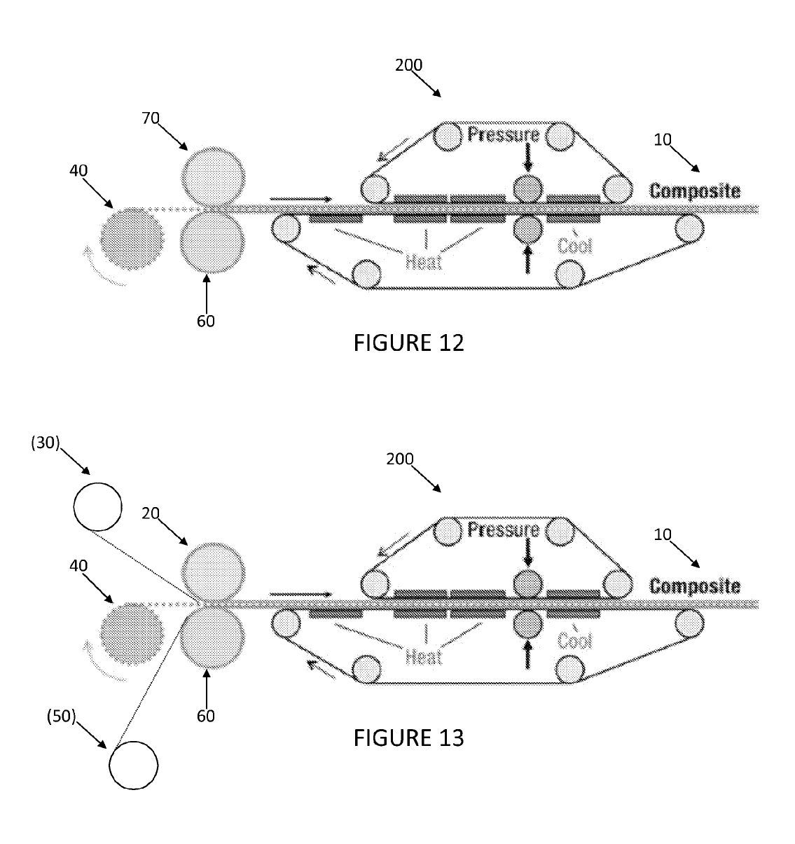

The Spunfab POF4002 adhesive may be pre-attached to the POPR-6's unglazed side. The unglazed side of the POPR-24 may face the DA-558, and on the opposite side of the DA-558, the unglazed side of the POPR-6 having the pre-attached POF 4002 provided thereon, may face the DA-558, such that the unglazed sides of the POPR-24 and the POPR-6 are facing each other. The entire assembly may enter into a laminator, such as a MEYER Flatbed-Laminator System (shown in FIGS. 8-13), which is a double belt press laminator 200 with integrated contact heating and cooling. Similar laminating devices may be employed without limitation.

### EXAMPLE 2

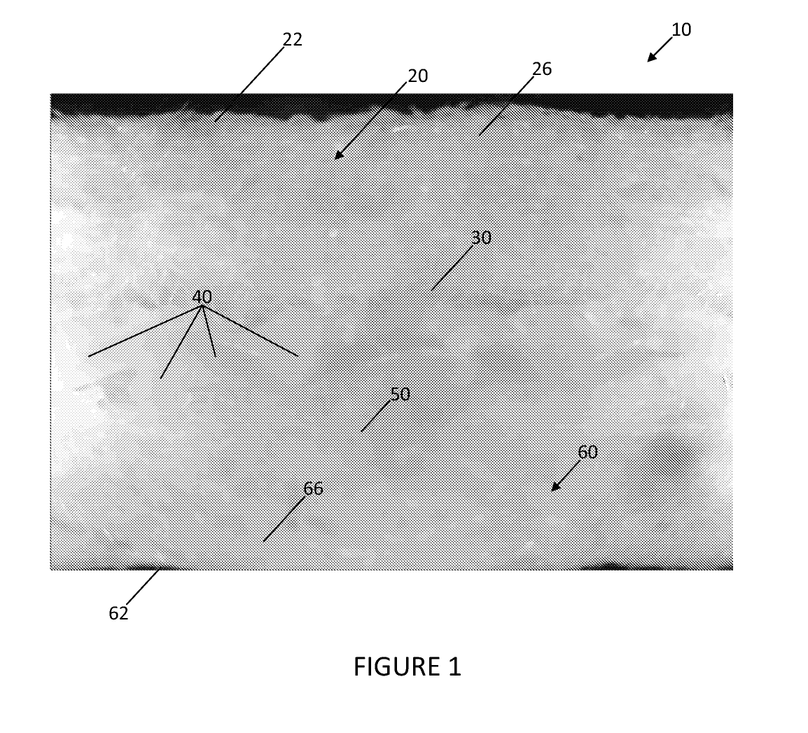

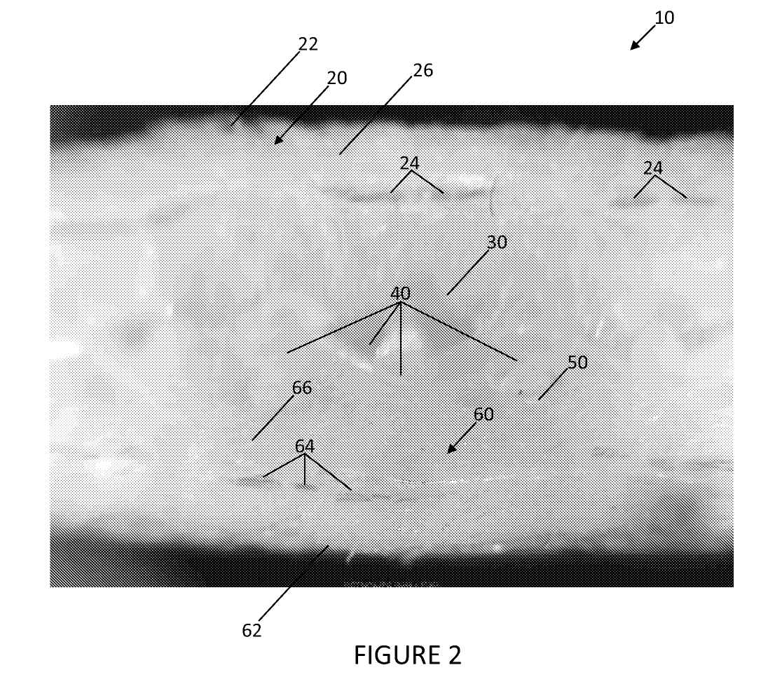

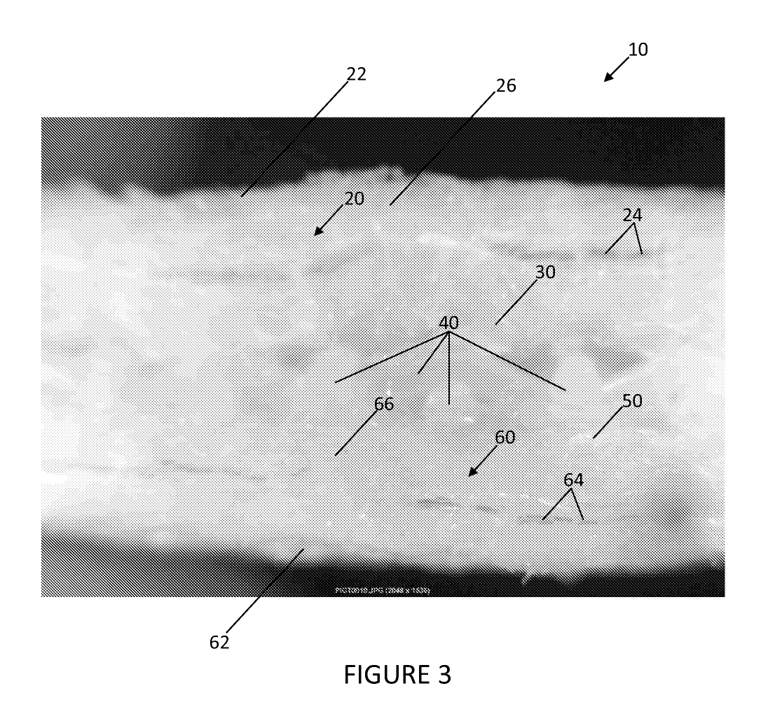

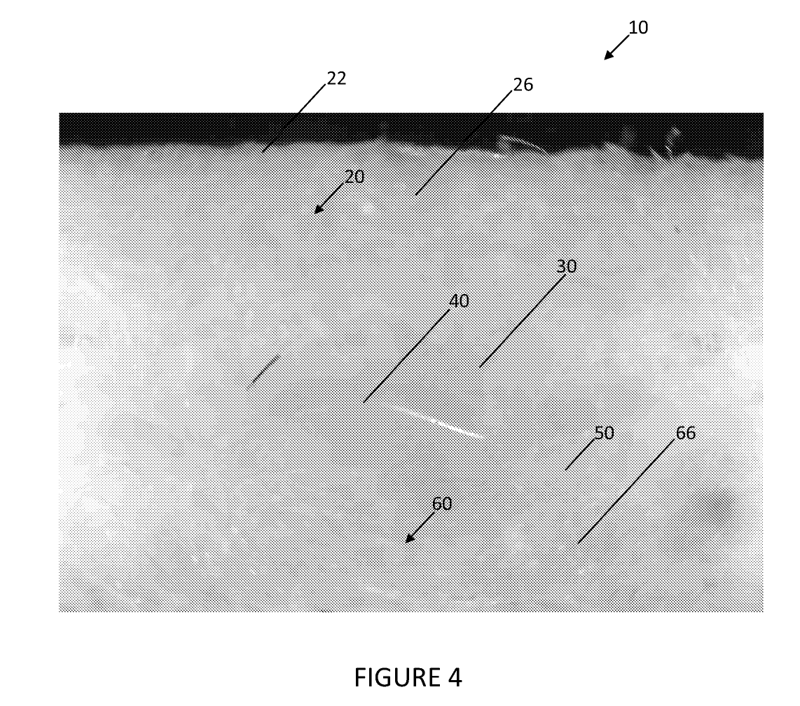

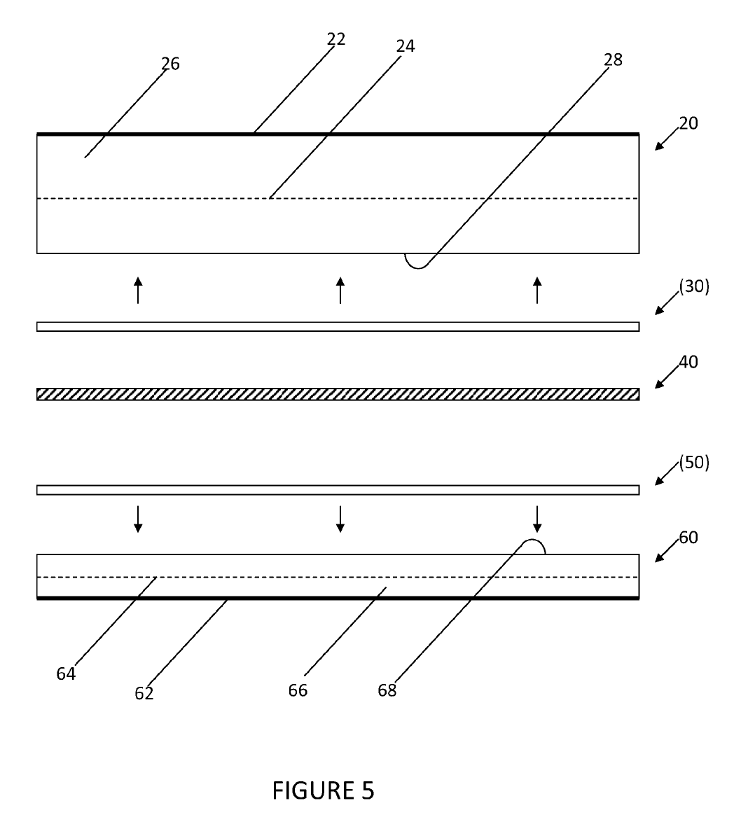

According to one proof of concept embodiment, a filter media prototype was formed of a composition of: 12 oz single glazed polypropylene scrim-supported needled felt, a sub layer of Spunfab POF4002 adhesive web, a middle layer of 18×18 mono-mono polyester 300F 60 sec; then another sub layer of POF4002 Spunfab POF4002 adhesive web, and finally a 12 oz single glazed polypropylene scrim-supported needled felt. The filter media prototype was formed under the following conditions: 300F 60 sec with 5 lbs pressure, and 75F 60 sec cooling with 5 lbs pressure. The final product can be seen in FIGS. 1-4.

Although the invention has been described in terms of particular embodiments and applications, one of ordinary skill in the art, in light of this teaching, can generate additional embodiments and modifications without departing from the spirit of or exceeding the scope of the claimed invention. It should be further noted that the particular geometries of components shown in the drawings are merely schematic representations and may vary from what is shown, and it is anticipated by the inventor that any number of variations and/or combinations of features or elements described herein may be practiced without departing from the scope of the invention.

Accordingly, it is to be understood that the drawings and descriptions herein are proffered by way of example to facilitate comprehension of the invention and should not be construed to limit the scope thereof.

What is claimed is:

1. A filter media (10) for dewatering slurry, comprising:
a first layer (20) comprising a polypropylene-containing fabric, the polypropylene-containing fabric comprising felt having a random needled felt weave;
a second layer (60) comprising a polypropylene-containing fabric, the polypropylene-containing fabric comprising felt having a random needled felt weave; and
a third layer (40) provided between the first layer and the second layer, the third layer comprising a polyester-containing fabric, the polyester-containing fabric comprising monofilament polyester;

2. The filter media of claim 1, wherein the first layer (20) is single-glazed (22), via a calendaring step.

3. The filter media of claim 1, wherein the second layer (60) is single-glazed (62), via a calendaring step.

4. The filter media of claim 1, wherein the first (20) and second (60) layers are single-glazed, via a calendaring step.

5. The filter media of claim 4, wherein the third layer (40) is provided most adjacent non-glazed portions (28, 68) of the first (20) and second (60) layers, such that single-glazed surfaces (22, 62) form outer working surfaces of the filter media (10), and the third layer (40) is internal to the filter media.

6. The filter media of claim 1, further comprising a fourth layer (30, 50) comprising an adhesive web.

7. The filter media of claim 6, wherein the fourth layer (30, 50) is pre-applied to at least one of the first (20) and second (00) layers.

8. The filter media of claim 6, wherein the adhesive web (30, 50) comprises a polyolefin having a melting temperature range of approximately 68° C.-130° C., a heat resistance temperature range of approximately 65-110° C., and a wash resistance temperature of approximately 30° C.

9. The filter media of claim 1, wherein the third layer (40) has a yarn configuration of monofilament-monofilament, a thread count of approximately 18×18 per inch, a plain weave, a heat set finish, a weight of approximately 12.5 ounces/square yard, and an open area of approximately 45%, may be provided.

10. The filter media of claim 1, wherein the second layer (60) has a weight of approximately 6 ounces/square yard, a permeability of approximately 20.0-30.0 CFM @ ½″ DWP, a Mullen Burst of approximately 150+, and a maximum continuous operating temperature of approximately 180° F.

11. The filter media of claim 1, wherein the first layer (20) has a weight of approximately 24 ounces/square yard, a permeability of approximately 5.0-8.0 CFM @ ½″ DWP, a Mullen Burst of approximately 450+, and a maximum continuous operating temperature of approximately 180° F.

12. A method of manufacturing filter media (10) for dewatering slurry, the filter media comprising:
a first layer (20) comprising a polypropylene-containing fabric, the polypropylene-containing fabric comprising felt having a random needled felt weave;
a second layer (60) comprising a polypropylene-containing fabric, the polypropylene-containing fabric comprising felt having a random needled felt weave; and
a third layer (40) provided between the first layer and the second layer, the third layer comprising a polyester-containing fabric, the polyester-containing fabric comprising monofilament polyester;
the method comprising the steps of:
providing the third layer (40) between the first layer (20) and the second layer (60);
feeding the first layer (20), second layer (60), and third layer (40) into a laminator having heating, cooling, and pressure capabilities;
applying heat to the first layer (20), second layer (60), and third layer (40);
applying pressure to the first layer (20), second layer (60), and third layer (40); and,
cooling the first layer (20), second layer (60), and third layer (40).

13. The method of claim 12, wherein the first layer (20) is single-glazed (22), via a calendaring step.

14. The method of claim 12, wherein the second layer (60) is single-glazed (62), via a calendaring step.

15. The method of claim 12, wherein the first (20) and second (60) layers are single-glazed, via a calendaring step.

16. The method of claim 15, wherein the third layer (30) is provided most adjacent non-glazed portions (28, 68) of the first (20) and second (60) layers, such that single-glazed surfaces form outer working surfaces of the filter media, and the third layer (40) is internal to the filter media (10).

17. The method of claim 12, further comprising a fourth layer (30, 50) comprising an adhesive web.

18. The method of claim 17, wherein the fourth layer (30, 50) is pre-applied to at least one of the first (20) and second (60) layers.

19. The method of claim 17, wherein the adhesive web comprises a polyolefin having a melting temperature range of approximately 68° C.-130° C., a heat resistance temperature range of approximately 65-110° C., and a wash resistance temperature of approximately 30° C.

20. The method of claim 12, wherein the third layer (40) has a yarn configuration of monofilament-monofilament, a thread count of approximately 18×18 per inch, a plain weave, a heat set finish, a weight of approximately 12.5 ounces/square yard, and an open area of approximately 45%, may be provided.

21. The method of claim 12, wherein the second layer (60) has a weight of approximately 6 ounces/square yard, a permeability of approximately 20.0-30.0 CFM @ ½″ DWP, a Mullen Burst of approximately 150+, and a maximum continuous operating temperature of approximately 180° F.

22. The method of claim 12, wherein the first layer (20) has a weight of approximately 24 ounces/square yard, a permeability of approximately 5.0-8.0 CFM @ ½″ DWP, a Mullen Burst of approximately 450+, and a maximum continuous operating temperature of approximately 180° F.

23. The method of claim 12, wherein the laminator (200) is a double belt press laminator with integrated contact heating and cooling.

24. The method of claim 23, wherein the double belt press laminator with integrated contact heating and cooling is a flatbed-laminator system.

25. The method of claim 12, wherein the step of applying heat to the first layer (20), second layer (60), and third layer (40) comprises maintaining between approximately 100 degrees F. to 400 degrees F. for approximately 10 seconds to 3 minutes.

26. The method of claim 25, wherein the step of applying heat to the first layer, second layer, and third layer comprises maintaining approximately 300 degrees F. for approximately 60 seconds.

27. The method of claim 12, wherein the step of applying pressure to the first layer (20), second layer (60), and third layer (40) comprises maintaining between approximately 1 and 10 lbs of pressure.

28. The method of claim 27, wherein the step of applying pressure to the first layer (20), second layer (60), and third layer (40) comprises maintaining approximately 5 lbs of pressure.

29. The method of claim 12, wherein the step of cooling the first layer (20), second layer (60), and third layer (40) comprises maintaining between approximately 50 and 100 degrees F. for approximately 10 seconds to 3 minutes.

30. The method of claim 29, wherein the step of cooling the first layer (20), second layer (60), and third layer (40) comprises maintaining approximately 75 degrees F. for approximately 60 seconds.
